(19) United States
(12) Patent Application Publication
(10) Pub. No.: US 2008/0141306 A1
(43) Pub. Date: Jun. 12, 2008

(54) METHOD OF SENDING MEDIA PROGRAM INFORMATION TO A SUBSCRIBER AND NODES THEREFOR

(75) Inventor: George Foti, Dollard des Ormeaux (CA)

Correspondence Address: ERICSSON CANADA INC.;PATENT DEPARTMENT, 8400 DECARIE BLVD., TOWN MOUNT ROYAL, QC, H4P 2N2, omitted

(73) Assignee: TELEFONAKTIEBOLAGET LM ERICSSON (PUBL), Stockholm (SE)

(21) Appl. No.: 11/608,045

(22) Filed: Dec. 7, 2006

(51) Int. Cl. G06F 3/00

(52) U.S. Cl. 725/44

(57) ABSTRACT

A method and nodes are introduced to allow pushing from a network towards an IP television (IPTV) terminal an Electronic Program Guide (EPG) in an optimized manner. An IPTV server stores a personalized EPG based on a generic EPG and on a subscriber profile. Upon changes to the personalized EPG, its content is pushed towards the IPTV terminal. According to one aspect of the invention, only changes from what the IPTV terminal has previously stored are being pushed down, thereby saving signalling bandwidth. For that purpose, the EPG as well as a user profile are presented and stored in eXtendable Markup Language (XML) format, allowing the use of XML Configuration Access Protocol for performing changes to the user profile from a Home Subscriber Server. Changes are then pushed towards the IPTV terminal.

### BACKGROUND OF THE INVENTION

1. Field of the Invention

The present invention relates to a method and to nodes for sending and presenting media program information to subscribers.

2. Description of the Related Art

An electronic program guide (EPG) server is a system that provides a program guide in electronic format to subscribers of a network. The main purpose with an EPG is that a subscriber can view the program guide on a television terminal rather than by use of a separate medium, such as for example by reading a newspaper. Detailed information about each program offered in the network is available by selecting information about a particular listing in the EPG. The EPG server is responsible for collecting EPG information from various sources, such as for example television channels, content providers, content aggregators and the like.

A prior art representation of a network used for internet protocol television (IPTV) is show in FIG. 1. The network 100 is shown comprising an IPTV terminal, for example a television set top box (STB) 110, an IPTV server 120 and the EPG server 130. The STB 110 is typically a device connected to the television terminal such as for example a television set, a mobile station, or a personal computer, and to an external television signal source, such as the IPTV server 120. The STB 110 converts a signal received from the signal source into a format capable of being displayed on the television terminal. Television programs are delivered to the STB 110 by use of an interface 140, typically supporting real time streaming protocol (RTSP).

Another interface 160 present between the IPTV server 120 and the EPG server 130 may be used to let the EPG server 130 provide program content information, that is a program listing and assorted information, to the IPTV server 120. It is not uncommon for IPTV services to comprise hundreds of channels. The amount of information within the EPG may thus be very large. A subscriber profile stored within the IPTV server 120 is used to produce for each subscriber a personalized EPG content, listing for example only the programs for a list of channels that the subscriber is authorized to access. The personalized EPG content is sent towards the STB 110 on the interface 140 for presentation to the subscriber. The entire content of the personalized EPG is typically sent towards the STB 110. Typically, the EPG server 130 updates the IPTV server 120 with refreshed content periodically, for example once a day, and the IPTV server 120 recalculates the personalized EPG contents for all subscribers at that time. New versions of the personalized EPG contents are then pushed in their entirety towards the subscribers.

If the EPG content changes for any reason, such as when a television program or a movie is added to or removed from a planned programming of a television station, the subscriber may not immediately be informed of the change. If the subscriber profile changes, for example through the addition of a channel to his list of authorized channels, the subscriber may not see what are the programs that he can now access, until the next daily update. Also, for elements of the EPG content that do not change as frequently as on a daily basis, sending the complete personalized EPG content to all subscribers once a day constitutes a waste of signalling resources between the IPTV server 120 and the STB 110.

There would be clear advantages of having a method and nodes for reducing the amount of program information that needs to be sent to the subscriber while providing accurate and up-to-date information.

### SUMMARY OF THE INVENTION

It is therefore a broad object of this invention to provide a method, an internet protocol television (IPTV) server and an IPTV terminal for sending media program information towards a subscriber.

A first aspect of the present invention is directed to a method of sending media program information to a subscriber. The method first stores a generic electronic program guide (EPG) content. A profile for the subscriber is also stored. Based on the generic EPG content and on the subscriber profile, a personalized EPG content is calculated for the subscriber. Information about the personalized EPG content is then sent towards the subscriber. Then, a change condition impacting the personalized EPG content is received. Responsive to the change condition, changes to the personalized EPG content are calculated. A changed personalized EPG content is stored and information is sent towards the subscriber about the changed personalized EPG content.

A second aspect of the present invention is directed to an IPTV server for supporting the method of sending media program information. Within the IPTV server, a generic electronic program guide (EPG) content is stored in a memory. The memory also stores in a table of subscriber entries, for each subscriber entry, a subscriber profile and a personalized EPG content. A control logic reads from the memory the generic EPG content and the subscriber profile, and instructs a processor to calculate the personalized EPG content based on the generic EPG content and on the subscriber profile. The result is stored in the memory by the control logic. An output port sends the personalized EPG content towards the subscriber. An input port receives a change condition. Responsive to the change condition, the control logic instructs the processor to calculate changes to the personalized EPG content based on the personalized EPG content and on the change condition. The control logic refreshes the personalized EPG content in the memory and instructs the output port to sends toward the subscriber information about the changes to the personalized EPG content.

A third aspect of the present invention is directed to an IPTV terminal, comprising a memory for storing an EPG content, an input port for receiving the EPG content and for receiving changes to the EPG content, and a processor for calculating a new version of the EPG content based on the EPG content and on the changes to the EPG content. A control logic reads from the memory the EPG content and instructs the processor to calculate a new version of the EPG content. The control logic stores in the memory the EPG content, when received at the input port, and the new version of the EPG content, when calculated by the processor.

### BRIEF DESCRIPTION OF THE DRAWINGS

For a more detailed understanding of the invention, for further objects and advantages thereof, reference can now be made to the following description, taken in conjunction with the accompanying drawings, in which:

FIG. 1 is a prior art representation of a network used for internet protocol television;

FIG. 2 shows steps in an exemplary method for sending media program information to a subscriber;

FIGS. 3a, 3b, 3c and 3d show steps in an exemplary method for sending updated media program information towards a subscriber;

FIG. 4 shows an exemplary construction of an IPTV server; and

FIG. 5 shows an exemplary construction of an IPTV terminal.

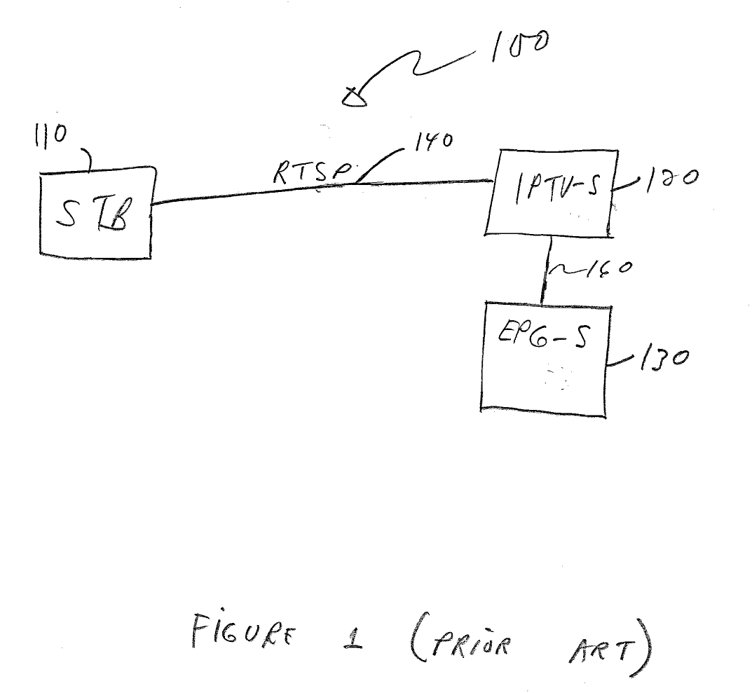

### DETAILED DESCRIPTION

The innovative teachings of the present invention will be described with particular reference to various exemplary uses and aspects of the preferred embodiment. However, it should be understood that this embodiment provides only a few examples of the many advantageous uses of the innovative teachings of the invention. In general, statements made in the specification of the present application do not necessarily limit any of the various claimed aspects of the present invention. Moreover, some statements may apply to some inventive features but not to others. In the description of the figures, like numerals represent like elements of the invention.

The present invention provides a method, an internet protocol television (IPTV) server and an IPTV terminal used for sending and presenting media program information to subscribers. In the context of the present invention, IPTV service and nodes is understood to encompass various TV services, including for example video on demand (VOD). Media program information may be pulled from the IPTV server by a subscriber, that is, sent upon request from the subscriber. Media program information may alternatively be pushed by the IPTV server towards the subscriber, meaning that the information is sent without request from the subscriber. Media program information for the subscriber may comprise a personalized electronic program guide (EPG). The personalized EPG is produced based on a generic EPG content and on a profile which is specific to the subscriber. Rather than sending the complete generic EPG content towards the subscriber, instead, the personalized EPG content is sent for presentation to the subscriber. The amount of information thus displayed at the IPTV terminal is significantly reduced.

The generic EPG content may comprise a list of media contents, such as IPTV programs, along with channels offering the media contents, time and date of the programs, pricing information, brief description of the programs, classification for parental guidance, and the like. The subscriber profile may comprise a list of channels that the subscriber is authorized to access, parental guidance information, maximum price per program, and the like. Preparation of the personalized EPG content may involve for example selection of programs based on a list of channels the subscriber is subscribed to, pricing information of some programs versus a maximum price defined in the profile, and the like.

The subscriber profile may be modified, upon request from the subscriber or following an operator command. Also, the generic EPG content may change at any time. According to the present invention, responsive to any of these events, changes to the personalized EPG content for the subscriber are calculated and sent, or pushed, towards the subscriber, without the need for any intervention from the subscriber.

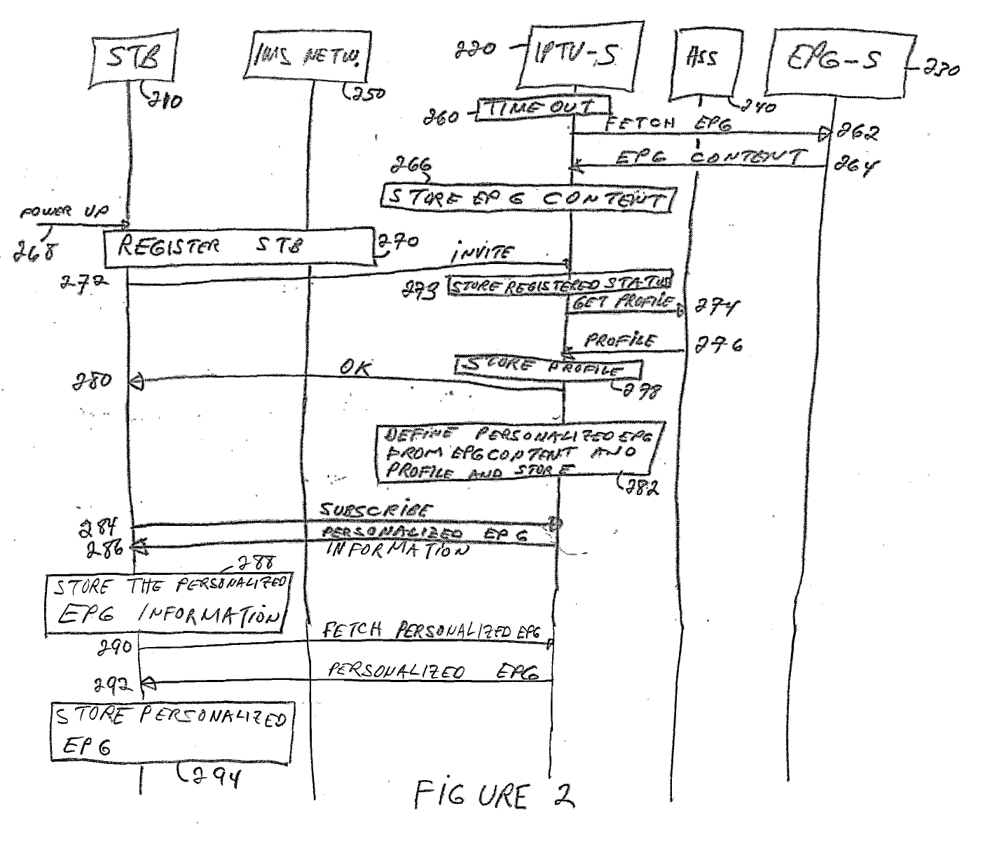

Some aspects of the present invention are described in reference to FIG. 2 which shows steps in an exemplary method for sending media program information to a subscriber. The exemplary method is implemented in a network comprising a set top box (STB) 210, an IPTV server 220, and an EPG server 230. The network preferably further comprises a home subscriber server (HSS) 240, or any other similarly suitable subscription database node, and an IP multimedia service (IMS) network 250. The IMS network 250 may comprise Call Control Serving Function (CSCF) nodes (not shown), as are well know in the art. The exemplary method is hereinbelow described, in most of its aspects, for a single subscriber. Those skilled in the art will readily recognize that the IPTV server 220, the EPG server 230, the HSS 240 and the IMS network 250 are typically capable of concurrently serving a very large number of subscribers. In the following description, the IPTV terminal is represented as the STB 210, although the latter can be distinct from the former. The invention also applies in cases where the IPTV terminal is embodied within an advanced television or multimedia terminal comprising the features of the set top box.

In a preferred embodiment, a timer within the IPTV server 220 generates a time out 260 at periodic intervals. Responsive to the time out 260, the IPTV server 220 sends a signal, preferably an Hypertext Transfer Protocol (HTTP) request, towards the EPG server 230 at step 262, requesting to fetch a generic EPG content. The EPG server 230 forwards the generic EPG content at step 264, preferably on an HTTP interface of the IPTV server 220, and the generic EPG content is stored in the IPTV server 220 at step 266, preferably in extensible Markup Language (XML) format.

At step 268, a user of the STB 210, generally the subscriber or someone related thereto, initiates powering up of a television set or other like terminal attached to the STB 210. Responsive to the power up, the STB 210 may register in the IMS network 250 at step 270. The STB 210 then sends at step 272 a message to the IPTV server 220, the message being for example a Session Initiation Protocol (SIP) Invite message. The SIP Invite message may be indicative that the subscriber has registered in the IMS network, in which case the IPTV server 220 may store a registered status of the subscriber at step 273. If the IPTV server 220 does not already have in store a profile for the subscriber, it fetches the profile from the HSS 240 at step 274. The HSS 240 replies with the subscriber profile at step 276 and the IPTV server 220 stores the profile at step 278. The IPTV server 220 may preferably send an acknowledgement to the STB 210 at step 280, for example in the form of a SIP 200 OK message.

The IPTV server 220 then calculates or otherwise defines a personalized EPG content, based on the generic EPG content and on the subscriber profile, and stores it locally, at step 282. While the generic EPG content may comprise programs in a large number of media channels supported by the IPTV server 220, the personalized EPG content may comprise programs in a limited number of media channels to which the subscriber is subscribed.

At step 284, the STB 210 may optionally send a request for media program information, for example in the form of a SIP Subscribe message, to the IPTV server 220. At step 286, the IPTV server 220 sends, either autonomously or in response to the SIP subscriber message, information about the personalized EPG content. When the IPTV server 220 sends the information autonomously, the method of the present invention provides a “push model” for providing the information. When the IPTV server 220 sends the information as a result of the request sent at step 284 from the STB 210, the STB 210 actually “pulls” the information. In one aspect, the actual content of the personalized EPG may be sent at step 286. The STB 210 then stores the content, at step 288. Alternatively, the information about the personalized EPG content sent at step 286 may consist of a pointer, for example in the form of a uniform resource locator (URL) pointing to a database, sent to the STB 210 at step 286. In that case, the STB 210 first stores the pointer at step 288. It then sends at step 290 a request for fetching the personalized EPG content, using the pointer, and receives at step 292 the personalized EPG content. The database indicated by the pointer may be the IPTV server 220 itself, or a separate database. In case where the personalized EPG content is fetched using the pointer, it is stored in the STB 210 at step 294.

The hereinabove description of FIG. 2 mentions several optional steps, some of which corresponding to a preferred embodiment of the present invention. In a simpler embodiment, the generic EPG content may be stored in the IPTV server 220 at step 266 at irregular intervals, for example by direct operator intervention, without the need for a separate EPG server 230. Likewise, subscriber profiles for a number of subscribers may be stored permanently, for example by an operator at step 278, in the IPTV server 220, rendering unnecessary any assistance from the HSS 240. The definition of the personalized EPG content for the subscriber at step 282 could in such a case be made at leisure, for example in moments of low traffic at the IPTV server 220. Delivery of the personalized EPG content to the STB 210 at step 286 could be made responsive to any signal used by the STB 210 to embody the request for program information. The request for program information could be made at step 272, if the personalized EPG content is already defined within the IPTV server 220, or at step 284. Finally, the ITPV server 220 could comprise an internal mechanism for initiating sending the information about the personalized EPG content towards the subscriber at step 286 without receiving the request for program information.

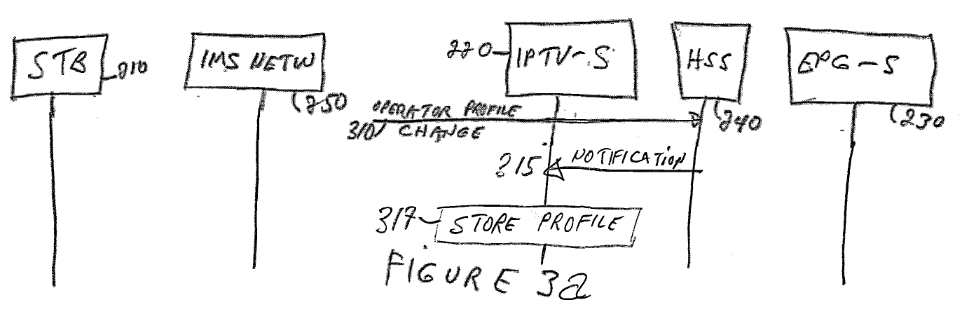

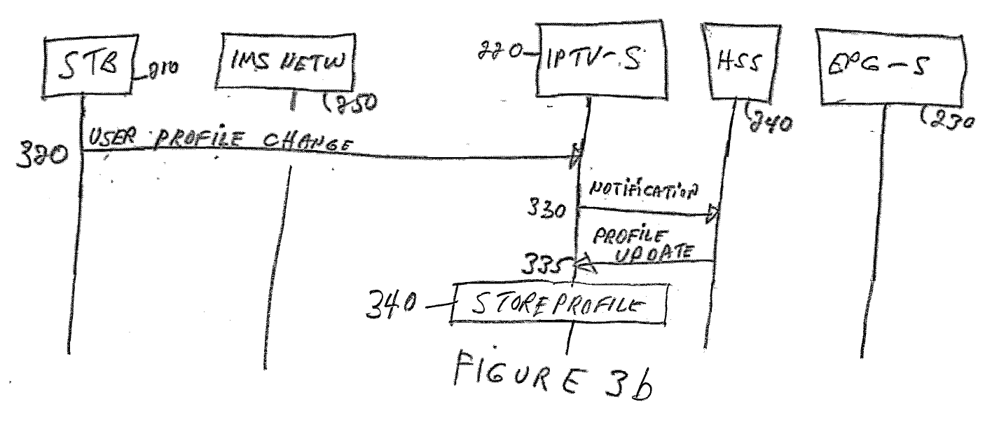

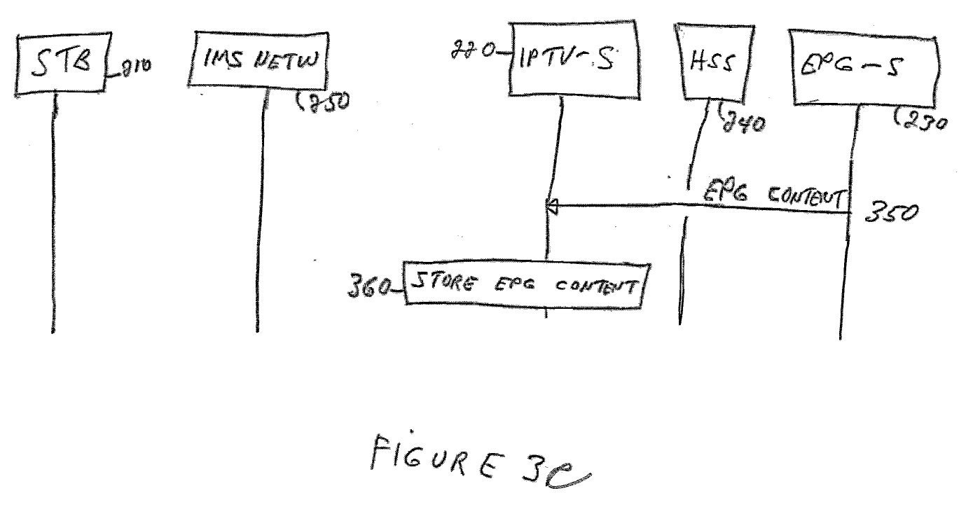

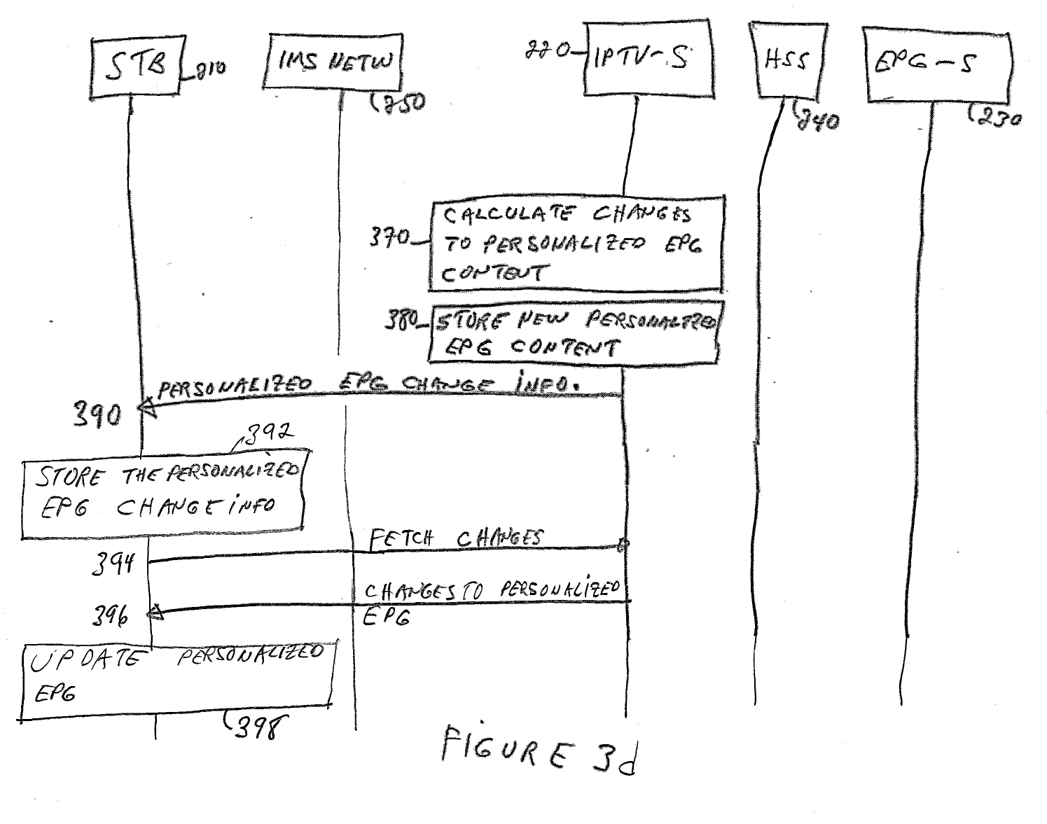

The information about the personalized EPG content having been sent towards the STB 210 by the IPTV server 220, as shown in the description of FIG. 2, various change conditions received at the IPTV server 220 may impact the media program information of interest to the subscriber. FIGS. 3a, 3b, 3c and 3d show steps in an exemplary method for sending updated media program information towards a subscriber. These figures illustrate nodes similar to those previously described in relation to FIG. 2. A sequence shown in FIG. 3d may be initiated in three ways, as shown in FIGS. 3a, 3b and 3c, each of which describe distinct change conditions impacting the personalized EPG content.

As shown on FIG. 3a, at step 310, an operator enters a command to change the subscriber profile stored in the HSS 240. The HSS 240 sends a notification to the IPTV server 220, to inform about the subscriber profile change at step 315. The notification may be received by use of a SIP interface of the IPTV server 220. The subscriber profile change received at the IPTV server 220 at step 315 is one of possible change conditions triggering changes to the personalized EPG content. The IPTV server 220 stores the changed subscriber profile at step 317. The sequence then continues at step 370, which is shown in the following description of FIG. 3d. The subscriber profile may alternatively be modified by user interaction, as shown on FIG. 3b. The user enters on the STB 210 a command for changing the subscriber profile, and the STB 210 forwards the command to the IPTV server 220 at step 320. The command of step 320 may be in the form of XML commands and may arrive at the IPTV server 220 on a XML Configuration Access Protocol (XCAP) interface. The IPTV server 220 sends a notification to the HSS 240 at step 330, indicative of the command to change the subscriber profile. The HSS 240 responds with an update to the subscriber profile at step 335. The notification may be sent by use of the SIP interface of the IPTV server 220, and the update may be received on the same SIP interface. The update to the subscriber profile received at the IPTV server 220 at step 335 also is a change condition triggering changes to the personalized EPG content. The IPTV server 220 stores a new version of the subscriber profile at step 340. The sequence then continues at step 370 of FIG. 3d.

As shown on FIG. 3c, the method for sending updated media program information towards the subscriber may also be initiated by a change in the generic EPG content received at the IPTV server 220 from the EPG server 230 at step 350. At step 360, a new version of the generic EPG content overwrites the version stored earlier at step 266. Changing the generic EPG content is another change condition triggering changes to the personalized EPG content. The sequence then continues at step 370 of FIG. 3d.

Whether the sequence is initiated by the change condition of steps 310 or 320, the IPTV server 220 calculates at step 370 changes to the personalized EPG content of the subscriber by use of the changed subscriber profile. A new version of the personalized EPG content is stored in the IPTV server 220 at step 380. The STB 210 is informed at step 390 of the new version of the personalized EPG content. In one aspect, the actual changes to the personalized EPG may be sent at step 390. The STB 210 then stores the changes to the content, at step 392. Alternatively, a URL pointing to a database may be sent to the STB 210 at step 390. In that case, the STB 210 stores the URL at step 392. The STB 210 sends a request for fetching the changes to the personalized EPG, at step 394, and receives the changes to the personalized EPG content, at step 396, using the URL. As before, the database indicated by the URL may point to the IPTV server 220 itself, or to a separate database. At step 398, the STB 210 updates the personalized EPG content by combining the content that had been stored at step 288 or at step 294 with the changes received at step 392 or at step 396.

In the case where the change condition initiating the sequence of FIG. 3d is the change in the generic EPG content at step 350, shown in FIG. 3c, calculation of changes to the personalized EPG contents is performed at step 370, by use of the changed generic EPG content, for a plurality of subscribers. Steps 380-398 are then performed independently for each subscriber.

Sending at step 390 of information about the changes to the personalized EPG content may be conditional to a verification in the IPTV server 220 of the registered status of the subscriber stored at step 273 of FIG. 2. As a result, step 390 may preferably be only performed when the STB 210 is for a registered subscriber, and therefore expected to be able to receive a message. Of course, this verification is especially suitable when the changes to the personalized EPG content were initiated at step 350, upon the change in the generic EPG content, because not all of the plurality of subscribers may be able to receive the message at the time of the change.

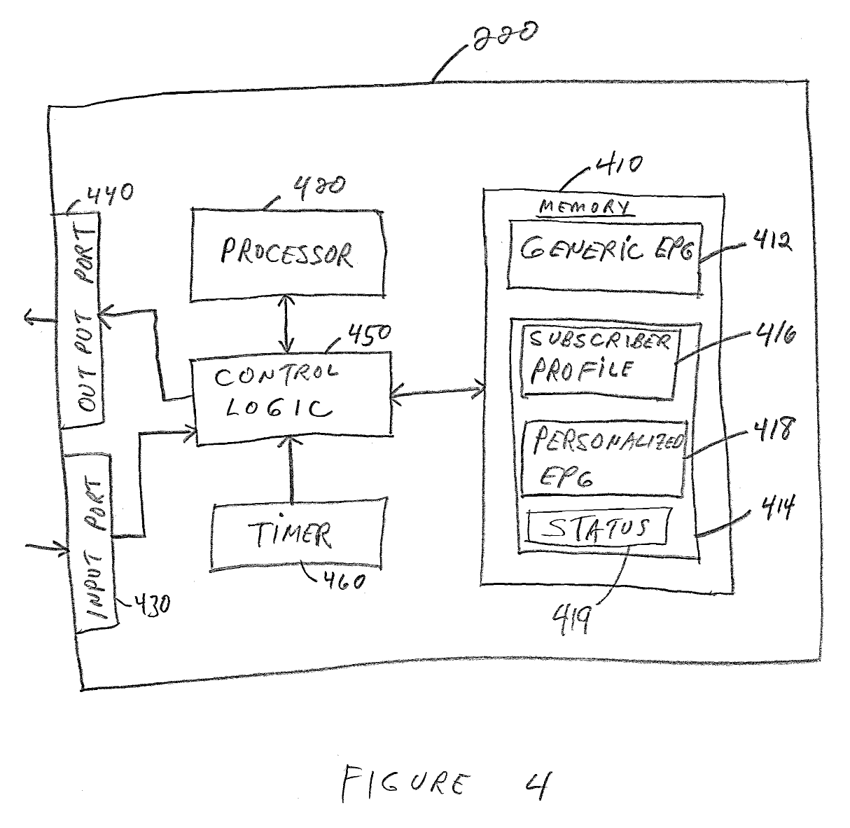

Having now described hereinabove a method of sending media program information to a subscriber, a node for supporting the method of the present invention will now be described by reference to FIG. 4 which shows an exemplary construction of an IPTV server as described in relation to the preceding figures. The IPTV server 220 comprises a memory 410, the memory 410 itself further comprising a generic EPG content 412, and a table for storing subscriber entries 414 comprising, for each subscriber, a subscriber profile 416 and a personalized EPG content 418. The IPTV server 220 also comprises a processor 420, an input port 430, and output port 440, a processor 450, and may comprise a timer 460.

The generic EPG content 412 may be stored in the memory 410 through various means. The generic EPG content 412 may be directly stored in the IPTV server 220 through an operator interface (not shown). Preferably, the generic EPG content 412 is received at the input port 430 from an external EPG server 230, receipt of the generic EPG content 412 being preferably over an HyperText Transfer Protocol (HTTP) supported by the input port 430. The input port 430 transfers the generic EPG content 412 to the control logic 450 which stores it in the memory 410. In one aspect of the present invention, the generic EPG content is stored in the memory 410 in XML format. Likewise, the subscriber profile 416 for a given subscriber entry 414 may be entered in the IPTV server 220 through the same operator interface (not shown), defined by configuration of the IPTV server 220, or may preferably be received from the HSS 240 or from a similar subscription database node. When the subscriber profile 416 is received at the input port 430, the control logic 450 stores it in the memory 410.

The control logic 450 reads both the generic EPG content 412 and the subscriber profile 416 from the memory and forwards them both to the processor 420, instructing it to calculate or otherwise define the personalized EPG content 418 for a subscriber. The personalized EPG content 418 is stored in the memory 410 by the control logic 450. The personalized EPG content 418 is also preferably stored in XML format. The reading, calculating and storing may be self-initiated by the control logic 450, for example when it determines that the personalized EPG content 418 for the subscriber is not yet defined and that a traffic load level of the IPTV server 220 is, at a given time, sufficiently low to warrant using the processor 420 for calculating the personalized EPG content 418. In an alternate embodiment, the personalized EPG content 418 is calculated upon receipt of a request from the subscriber. The input port 430 receives such a request in the form of a request for media program information, which may itself be embodied in a SIP Subscribe message. The input port 430 forwards the request to the control logic 450. If the personalized EPG content 418 for the subscriber who originated the request is not yet defined, the control logic 450 instructs the processor 420 to calculate it and the memory 410 to store it, as described hereinabove. Whether the personalized EPG content 418 was previously defined, or defined upon request, the control logic 450 instructs the output port to 440 send information about the personalized EPG content 418 towards the subscriber.

The input port 430 may receive information indicating that the subscriber has registered in an access network, for example in an IMS network. The information may be comprised in a SIP Invite message. The control logic 450 then preferably stores in the subscriber entry 414 a status 419 to indicate that the subscriber is registered. Later when the subscriber leaves the access network, for example by turning off or logging off from the STB 210, a deregistration signal is received at the input port 430. The status 419 is in that case updated by the control logic 450 to indicate that the subscriber is not registered. In some embodiments, receipt of the information indicating that the subscriber has registered may constitute the request for media program information. In some embodiments, responsive to receiving the information indicating that the subscriber has registered, the control logic 450 instructs the output port 440 to send to the HSS 240 a request for fetching the subscriber profile 416, the request possibly being sent as an HTTP message.

The IPTV server 220 may comprise the timer 460. The timer 460 generates a periodic time out signal, for example once per day, and provides the time out signal to the control logic 450. Responsive to the time out signal, the control logic 450 instructs the output port 440 to send a request to fetch a new generic EPG version to the EPG server 230. The EPG server 230 sends the new generic EPG version which arrives at the input port 430.

Whether the EPG server 230 sends the new generic EPG version responsive to a request from the IPTV server 220, or as a result of some other event within the EPG server 230, whenever the new generic EPG version arrives at the input port 430, the input port 430 informs the control logic 450 of the new generic EPG version. The control logic 430 overwrites the generic EPG content 412 with the new generic EPG version. The control logic 450 also considers the new generic EPG version received at the input port 430 as a change condition impacting the personalized EPG contents 418 for subscribers, and therefore instructs the processor to calculate changes to the personalized EPG contents 418, based on the new generic EPG version, for all subscribers having a subscriber entry 414 in the memory 410. The personalized EPG contents 418 are refreshed in the memory 410 by the control logic 450. The control logic 450 further instructs the output port 440 to send information towards all subscribers about changes to their personalized EPG content. Preferably, the control logic 450 may instruct the output port 440 to send information about changes to the personalized EPG contents only for those subscribers who have their status 419 indicating that they are registered.

The input port 430 may receive an update to the subscriber profile 416, and inform the control logic 450. The control logic 450 considers the update to the subscriber profile 416 received at the input port 430 as a change condition impacting the personalized EPG contents 418 for the subscriber, and therefore instructs the processor 420 to calculate changes to the personalized EPG content 418 based on the update. The control logic 450 then refreshes in the subscriber entry 414 the subscriber profile 416 and further refreshes the personalized EPG content 418 based on the changes. The control logic 450 then instructs the output port 440 to send information about the changes to the personalized EPG content 418 towards the subscriber.

The IPTV server 220 may send information about the personalized EPG content 418, and information about the changes thereto, in various manners. The complete personalized EPG content 418 and the complete changes to the personalized EPG content may be sent by the output port 440 in messages towards the subscriber. In some embodiments, the personalized EPG content 418 and changes thereto are sent within SIP messages. Alternatively, information about the personalized EPG content 418 and information about changes thereto may be sent in the form of pointers such as for instance URLs pointing to the IPTV server 220 or to a separate database. In the case where the information consists of URLs pointing to the IPTV server 220, the input port 430 may receive an HTTP request at a first URL and forward the request to the control logic 450. The control logic 450 reads the personalized EPG content 418 from the memory and instructs the output port 440 to send the personalized EPG content 418 towards the subscriber. The input port 430 may then receive another HTTP request at a second URL and forward the request to the control logic 450. The control logic 450 reads the changes to the personalized EPG content from the memory which, in this case, needs to store at least temporarily the actual changes separately from the personalized EPG content 418. The control logic 450 then instructs the output port 440 to send the changes to the personalized EPG content towards the subscriber.

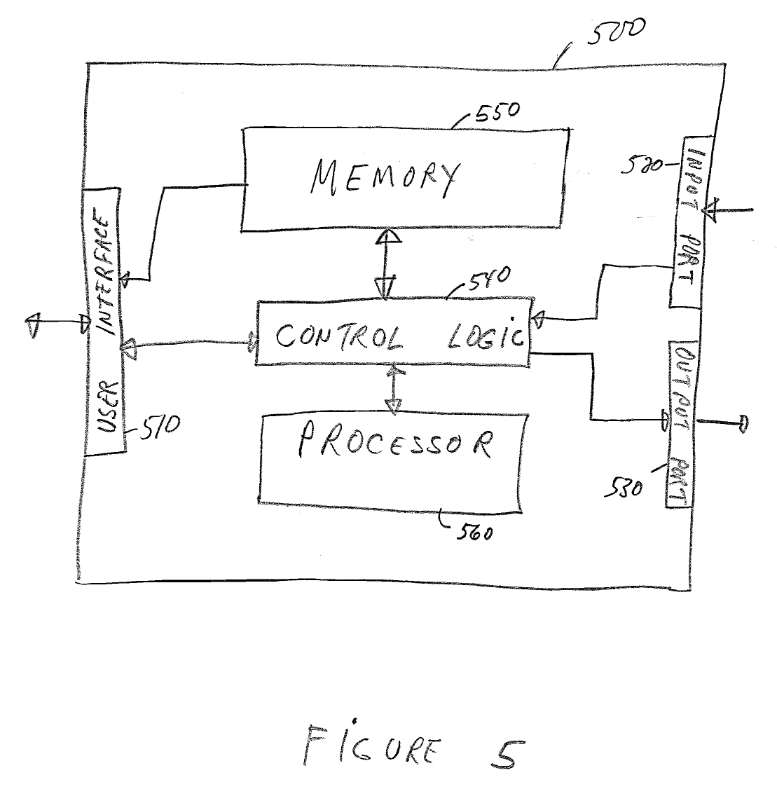

Another node for supporting the method of the present invention will now be described by reference to FIG. 5 which shows an exemplary construction of an IPTV terminal as used in the preceding figures. The exemplary IPTV terminal 500 comprises an input port 520, a control logic 540, a memory 550, and a processor 560, and may further comprise a user interface 510 and an output port 530. The IPTV terminal 500 may be embodied in the STB 210 discussed in the preceding figures. The IPTV terminal 500 may alternatively be integrated within an advanced television set, in a mobile terminal or a personal computer capable of receiving IPTV programs, or in any device suitable for presenting IPTV programs.

The memory 550 is capable of storing an EPG content. Because the IPTV terminal 500 is generally used by one subscriber, the EPG content is essentially the same as one personalized EPG content as discussed hereinabove. When the subscriber turns on the IPTV terminal, or a suitable terminal device attached thereto, the user interface 510 may receive a power on or a logging command and inform the control logic 540. The control logic 540 may instruct the output port 530 to send a registration signal towards an IMS network, and wait for a response to the registration signal arriving at the input port 520. The control logic may then request the output port 530 to send towards the IPTV server 220 a request for receiving the EPG content. Information about the EPG content arrives at the input port 520, either responsive to the request for receiving the EPG content, or as a result of an internal initiating mechanism within the IPTV server 220. In one embodiment, the information contains the actual EPG content. The input port 520 informs the control logic 540 of the received EPG content. In an alternate embodiment, the information received at the input port 520 comprises a first URL. The control logic 540 instructs the output port 530 to send towards the first URL a request message for fetching the EPG content. The EPG content arrives at the input port 520 which forwards it to the control logic 540. The control logic 540 writes the EPG content into the memory 550. Thereafter, the control logic 540 may instruct the user interface 510 to present the EPG content to the subscriber. Alternatively, the EPG content may only be presented to the subscriber when a request for presentation is received at the user interface 510.

The subscriber may enter at the user interface 510 a request for changing a subscriber profile. Responsive to the request, the control logic 540 instructs the output port 530 to forward towards the IPTV server 220 the request for changing the subscriber profile. The input port 520 then receives a message providing information about changes to the EPG content. The message may actually list the changes to the EPG content and the input port 520 forwards the list to the control logic 540. Alternatively, the message may comprise a second URL, in which case the control logic 450 instructs the output port 530 to send towards the second URL a request for fetching the changes to the EPG content. The changes to the EPG content arrive at the input port 520, which forwards this information to the control logic 540. The control logic 540 reads from the memory 550 the EPG content and instructs the processor 560 to calculate a new version of the EPG content based on the EPG content stored earlier and on the changes. The control logic 550 then overwrites in the memory 550 the EPG content with the new version of the EPG content.

Although several aspects of the preferred embodiment of the method, the IPTV server and the IPTV terminal of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

1. A method of updating media program information of a subscriber from a node storing a personalized electronic program guide (EPG) content, the method comprising the steps of:
a. receiving a change condition affecting the personalized EPG content;
b. calculating changes to the personalized EPG content based on the change condition; and
c. sending towards the subscriber the changes to the personalized EPG content.

2. The method of claim 1, further comprising the step of:
d. following step b. sending towards a terminal used by the subscriber a pointer for fetching the changes to the personalized EPG content; and
wherein step c. is responsive to receiving a request for fetching the changes to the personalized EPG content.

3. The method of claim 2, wherein:
the pointer is a uniform resource locator (URL).

4. The method of claim 1, wherein:
a subscriber profile defines channels that the subscriber is authorized to access; and
the personalized EPG content is calculated by selecting from a generic EPG content the channels that the subscriber is authorized to access.

5. The method of claim 4, wherein:
the change condition is an update to the subscriber profile; and
calculating changes to the personalized EPG content is based on the update.

6. The method of claim 4, wherein:
the change condition is a new version of the generic EPG content; and
calculating changes to the personalized EPG content is based on the new version of the generic EPG content.

7. The method of claim 6, wherein:
the generic EPG content is overwritten at periodic intervals.

8. The method of claim 6, wherein:
the changes to the personalized EPG content are sent following verification of a registered status of the subscriber.

9. The method of claim 4, wherein:
the generic EPG content is received from an EPG server.

10. The method of claim 4, wherein:
the subscriber profile is received from a home subscriber server (HSS).

11. The method of claim 1, wherein:
the node storing the personalized EPG content is an internet protocol television (IPTV) server.

12. The method of claim 1, wherein:
the personalized EPG content is stored responsive to receiving an indication that the subscriber has registered in an internet protocol multimedia service (IMS) network.

13. An internet protocol television (IPTV) server storing a personalized electronic program guide (EPG) content, comprising:
an input port for receiving a change condition affecting the personalized EPG content;
a processor for calculating changes to the personalized EPG content based on the change condition;
an output port for sending towards the subscriber the changes to the personalized EPG content; and
a control logic for instructing the processor to calculate the changes to the personalized EPG content, and for instructing the output port to send the changes to the personalized EPG content.

14. The IPTV server of claim 13, wherein:
after calculation of the changes to the personalized EPG content, the control logic instructs the output port to send towards the subscriber a pointer for fetching the changes to the personalized EPG content.

15. The IPTV server of claim 14, wherein:
the pointer are is a uniform resource locator (URL).

16. The IPTV server of claim 14, wherein:
the input port further receives a request for fetching the changes to the personalized EPG content; and
the control logic, responsive to the request, instructs the output port to send the changes to the personalized EPG content.

17. The IPTV server of claim 13, further comprising:
a memory for storing a generic EPG content, the memory further comprising a table for storing subscriber entries, wherein each subscriber entry comprises a subscriber profile and the personalized EPG content; and
wherein the personalized EPG content is calculated by the processor based on the generic EPG content and on the subscriber profile.

18. The IPTV server of claim 17, further comprising:
a timer for periodically sending a time out signal to the control logic;
wherein the control logic, responsive to the time out signal, instructs the output port to send a request for fetching the generic EPG content towards an EPG server.

19. The IPTV server of claim 17, wherein:
the change condition is a receipt of a new generic EPG version;
the input port informs the control logic of the receipt of a new generic EPG version; and
the control logic instructs the processor to calculate the changes to the personalized EPG contents for each of the subscriber entries based on the new generic EPG version.

20. The IPTV server of claim 19, wherein:
the input port further receives registration information for a given subscriber;
responsive to the receipt of the registration information for the given subscriber, the control logic stores in the memory a status for the given subscriber; and
the control logic instructs the output port to send the changes to the personalized EPG content towards the given subscriber upon verification of the status.

21. The IPTV server of claim 17, wherein:
the change condition is an update to the subscriber profile;
the control logic instructs the processor to calculate changes to the personalized EPG content based on the update; and
the control logic refreshes in the subscriber entry the subscriber profile and further refreshes the personalized EPG content based on the changes to the personalized EPG content.

22. The IPTV server of claim 17, wherein:
the input port further receives registration information for the subscriber;
the control logic, responsive to the registration information, instructs the output port to fetch the subscriber profile from a home subscriber server (HSS); and
the input port further receives the subscriber profile.

23. An internet protocol television (IPTV) terminal, comprising:
a memory for storing an electronic program guide (EPG) content;
an input port for receiving changes to the EPG content;
a processor for calculating a new version of the EPG content based on the EPG content and on the changes to the EPG content; and
a control logic for instructing the processor to calculate a new version of the EPG content and for storing in the memory the new version of the EPG content.

24. The IPTV terminal of claim 23, further comprising:
an output port for sending messages towards uniform resource locators (URL), wherein:
the input port receives a first URL;
the control logic instructs the output port to send towards the first URL a request for fetching the EPG content;
the input port receives a second URL; and
the control logic instructs the output port to send towards the second URL a request for fetching the changes to the EPG content.

25. The IPTV terminal of claim 23, further comprising:
a user interface for receiving a power on command; and
an output port for sending a registration signal towards an internet protocol multimedia (IMS) network;
wherein the control logic, responsive to the power on command, instructs the output port to send the registration signal.

26. The IPTV terminal of claim 23, further comprising:
a user interface for receiving a request for changing a subscriber profile; and
an output port for forwarding towards the IPTV server the request for changing the subscriber profile;
wherein the control logic instructs the output port to forward the request for changing the subscriber profile.

27. The IPTV terminal of claim 26, wherein:
the user interface further presents the EPG content to a user.

28. The IPTV terminal of claim 23, wherein:
the IPTV terminal is a set top box.
